(19) United States
(12) Patent Application Publication
(10) Pub. No.: US 2013/0199523 A1
(43) Pub. Date: Aug. 8, 2013

(54) PORTABLE OXYGEN SUPPLY SYSTEM

(71) Applicant: Chun- Chun CHEN, Taipei City (TW)

(72) Inventor: Chun- Chun CHEN, Taipei City (TW)

(21) Appl. No.: 13/367,050

(22) Filed: Feb. 6, 2012

(51) Int. Cl. A62B 7/02; G01S 1/02; A62B 18/02; F21V 33/00

(52) U.S. Cl. 128/202.13

(57) ABSTRACT

A portable oxygen supply system includes an oxygen supply device, a wireless transmission unit, an illumination device, a gas adjuster, a respiratory mask, and a wireless receiver unit. The oxygen supply device includes an oxygen storage space, a bottom portion, and a connecting portion. The bottom portion is provided underside the oxygen supply device and has an accommodating space for the wireless transmission unit. One end of the connecting portion is connected to the illumination device, and the other end is connected to the gas adjuster. The wireless transmission unit includes an operation control unit, a microprocessor, a wireless transmitter, and a positioning transmitter. The illumination device is connected in front of the connecting portion for illumination. The gas adjuster is connected between the oxygen supply device and the respiratory mask for adjusting the flow amount of the outputted oxygen. The oxygen supply device outputs oxygen to the respiratory mask.

### BACKGROUND OF THE INVENTION

1. Field of the Invention

The present invention relates to a portable oxygen supply system, and in particular to a portable oxygen supply system in which a wireless transmission unit and a wireless receiver unit are provided. Further, the present invention is capable of adjusting the output amount of oxygen and providing illumination.

2. Description of Prior Art

When a fire happens, according to statistical data, more than 90% people are not burned to death but died by choke or fall down in a faint because they inhale too much dense smoke. Further, in case of fire, electric power supply near the fire scene is often burned down or shut down, the fire scene may get so dark that people cannot find the exit easily. As a result, the crowd fluster and get trapped in the fire scene, which increases the difficulty in rescue.

The current portable oxygen supply system available in the market can be carried about and its function is not restricted by special conditions. For example, a conventional portable oxygen supply system includes a oxygen cylinder containing liquid oxygen therein, an oxygen-feeding control device and a nose-covering device. The characteristic of this prior art lies in that: after a nose mask of the nose-covering device is put to cover the nose of a user, the user opens the oxygen-feeding device, so that the oxygen cylinder can provide the liquid oxygen contained therein to the user for emergency rescue at any time and place. Such a conventional portable oxygen supply device can be carried about by anyone and its function will not be restricted by the special conditions. Thus, the user who has this portable oxygen supply system can save his/her life and save others'. Although the above-mentioned conventional portable oxygen supply system can provide oxygen, it still has some drawbacks. For example, when rescue personnel perform a rescue task in a disaster scene, since the disaster scene is full of smoke and there is no lamplight, the difficulty in rescue is increased. Further, such a conventional portable oxygen supply system cannot adjust the output amount of oxygen, so that the outputted oxygen may not be inhaled completely and thus a portion of the oxygen is wasted

According to the above, although the above portable oxygen supply system can provide oxygen to save the life of a trapped person, it cannot increase the convenience in rescue and shorten the time for rescue.

Therefore, there is still room for improvement in those conventional portable oxygen supply systems.

### SUMMARY OF THE INVENTION

In view of the above, the primary objective of the present invention is to provide a portable oxygen supply system having a wireless transmission unit and a wireless receiver unit. The wireless transmission unit transmits wireless signals in case of fire and the wireless receiver unit receives the corresponding wireless signals. By this structure, a user can be positioned for easy rescue.

Another objective of the present invention is to provide a portable oxygen supply system, which is capable of turning on a lamp in case of fire, so that a user can find the exit easily by using the lamp.

A further objective of the present invention is to provide a portable oxygen supply system, which is capable of adjusting the output amount of oxygen based on practical demands.

In order to achieve the above objectives, the portable oxygen supply system of the present invention includes a oxygen supply device. One end of the oxygen supply device is provided with an accommodating chamber in which a wireless transmission unit is provided. The other end of the oxygen supply device is provided with an illumination device and a gas adjuster. The present invention further has a wireless receiver unit for receiving signals indicating the location of a wireless transmitter.

### BRIEF DESCRIPTION OF THE DRAWINGS

FIG. 1 is an assembled perspective view showing a preferred embodiment of the present invention;

FIG. 2 is a cross-sectional view showing the embodiment of the present invention;

FIG. 3 is a block view showing the wireless transmission unit of the embodiment of the present invention; and

FIG. 4 is a block view showing the wireless receiver unit of the embodiment of the present invention.

### DETAILED DESCRIPTION OF THE INVENTION

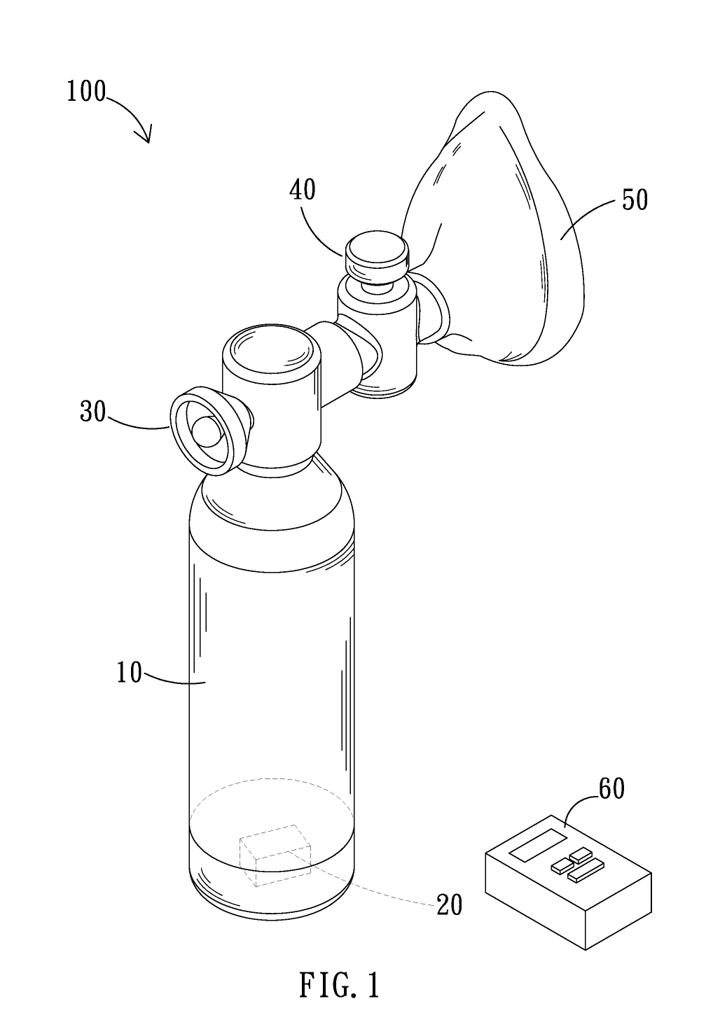

In order to make the Examiner to better understand the characteristics and features of the present invention, a description relating thereto will be made with reference to a preferred embodiment thereof and accompanying drawings. Please refer to FIGS. 1 to 4. The present invention provides a portable oxygen supply system 100, which includes an oxygen supply device 10, a wireless transmission unit 20, an illumination device 30, a gas adjuster 40, a respiratory mask 50, and a wireless receiver unit 60.

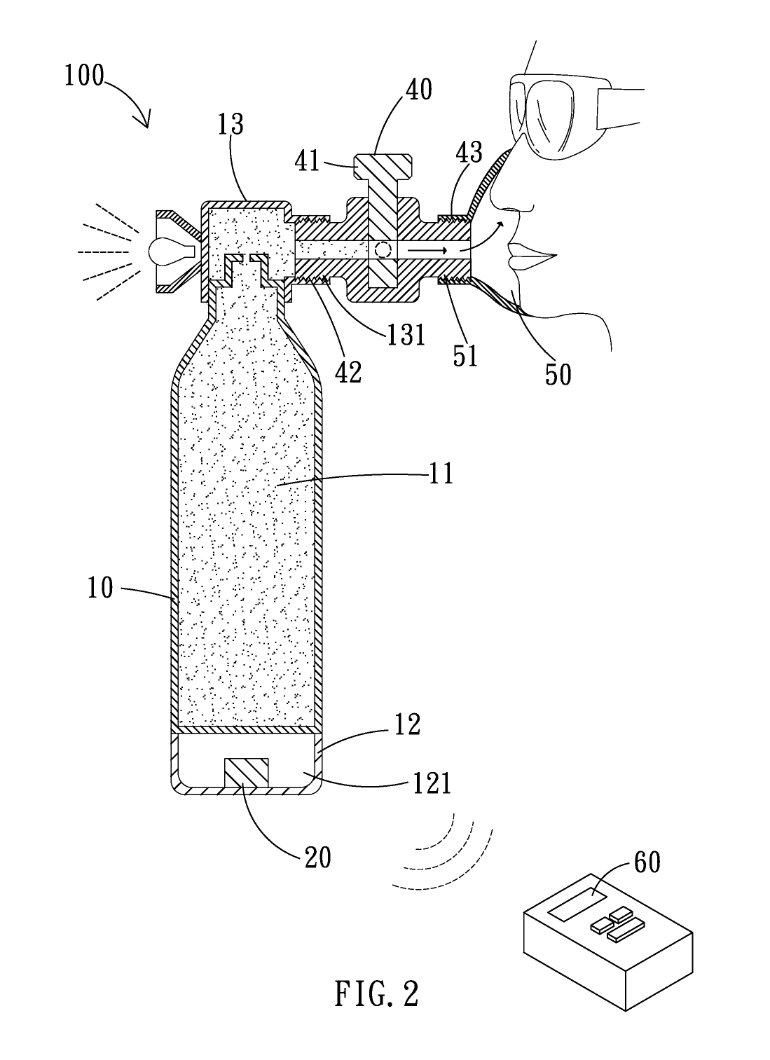

Please refer to FIGS. 1 and 2. The oxygen supply device 10 is formed into a cylinder and has an oxygen storage space 11. The underside of the oxygen supply device 10 is provided with a bottom portion 12. The bottom portion 12 is provided with an accommodating space 121. An end of the oxygen supply device 10 is provided with a connecting portion 13. The connecting portion 13 has a conduit 131 in communication with a gas connector 42 of the gas adjuster 40.

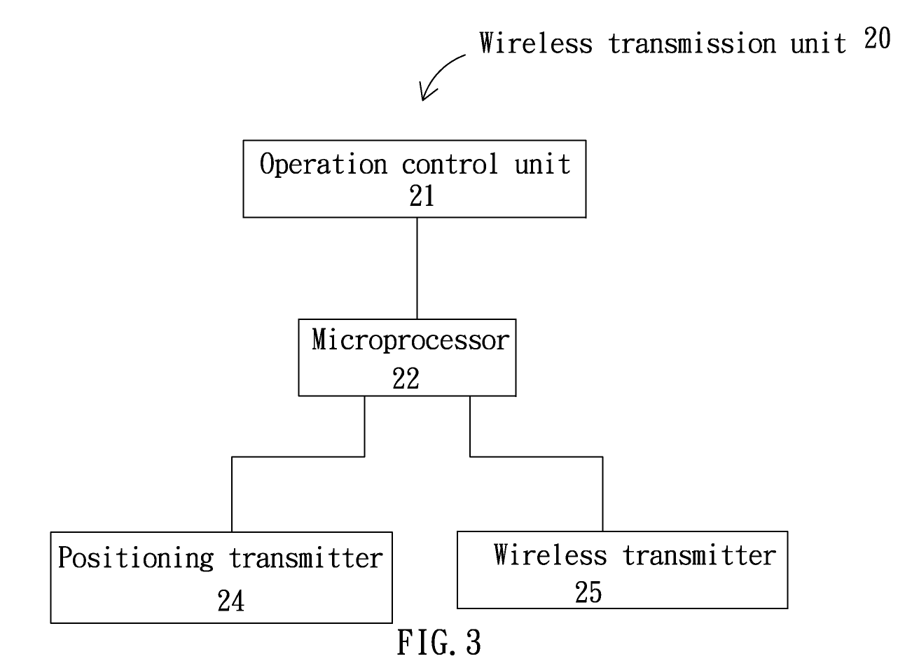

Please refer to FIGS. 2 and 3. The wireless transmission unit 20 is provided in the accommodating space 121 and includes an operation control unit 21, a microprocessor 22, a wireless transmitter 23, and a positioning transmitter 24. After the operation control unit 21 is activated, the microprocessor 22 can transmit a command to the wireless transmitter 23 to transmit wireless signals.

Further, the illumination device 30 is connected to the connecting portion 13 of the oxygen supply device 10 for illuminating the surrounding environment.

The gas adjuster 40 comprises an adjusting switch 41, a gas connector 42 and a stationary connector 43. The adjusting switch 41 is provided on the upside of the gas adjuster 40 for adjusting the flow amount of oxygen. The gas adjuster 40 is a bi-pass connecting tube. One end of the gas adjuster 40 is the gas connector 42 connected to the conduit 131 of the connecting portion 13 for receiving the oxygen outputted by the oxygen supply device 10. The other end of the gas adjuster 40 is connected to a respiratory pipe 51 of the respiratory mask 50.

Please refer to FIGS. 1 to 2. The respiratory mask 50 has a respiratory pipe 51 in communication with the stationary connector 43 of the gas adjuster 40, so that the outputted oxygen can be delivered into the respiratory mask 50.

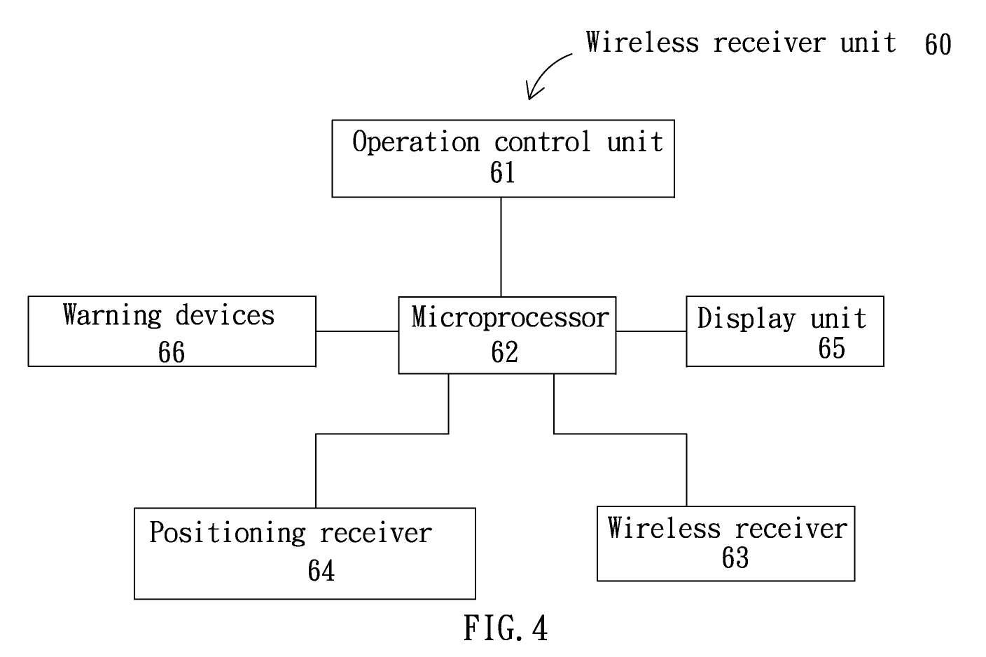

Please refer to FIGS. 2 and 4. The wireless receiver unit 60 includes an operation control unit 61, a microprocessor 62, a wireless receiver 63, a positioning receiver 64, a display unit 65, and a warning device 66. The wires receiver unit 60 is configured to receive the signals transmitted by the wireless transmission unit 20. More specifically, the operation control unit 61 activates the microprocessor 62, and the display unit 65 can display the operation state. When the wireless receiver 63 of the wireless receiver unit 60 receives the signals transmitted by the wireless transmission unit 20, the microprocessor 62 activates the warning device 66 to generate a warning signal such as a sound, vibration or light, wherein the warning device is a buzzer, a LED indicator, and a vibration motor. When the wireless transmission unit 20 is getting closer, the warning signal of the warning device 66 becomes stronger. Alternatively, the positioning receiver 64 such as an assisted global positioning system (A-GPS), is configured to receive the signals generated by the positioning transmitter 24.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A portable oxygen supply system, including:
an oxygen supply device having a bottom portion on its underside, the bottom portion being provided with an accommodating space, the upside of the oxygen supply device being provided with a connecting portion;
a wireless transmission unit provided in the accommodating space and comprising an operation control unit, a microprocessor, a wireless transmitter, and a positioning transmitter, the operation control unit being coupled to the microprocessor via logic circuit for controlling an ON/OFF state of the wireless transmission unit, the wireless transmitter being configured to transmit signals processed by the microprocessor, the positioning transmitter being configured to transmit a signal indicating a location of a user;
an illumination device connected to the connecting portion of the oxygen supply device for illuminating a surrounding environment;
a gas adjuster having an adjusting switch on its upside for adjusting a flow amount of the outputted oxygen, the gas adjuster being connected to the connecting portion;
a respiratory mask with its one end connected to the gas adjuster and the other end adhered to a face of the user;
a wireless receiver unit comprising an operation control unit, a microprocessor, a wireless receiver, a positioning receiver, a display unit, and a warning device, the operation control unit being coupled to the microprocessor via logic circuit, the microprocessor being configured to process signals received by the wireless receiver and display the processed signals on the display unit and the warning unit, the positioning receiver being configured to receive a signal indicating a location of the wireless transmission unit;
whereby the wireless transmission unit transmits a signal to the wireless receiver unit, once the wireless receiver unit receives the signal transmitted by the wireless transmission unit, the warning device is activated to generate a warning signal.

2. The portable oxygen supply system according to claim 1, wherein the positioning receiver is a satellite positioning device with an assisted global positioning system (A-GPS).

3. The portable oxygen supply system according to claim 1, wherein the warning device is any one of a buzzer, a LED indicator, and a vibration motor.
